(19) United States
(12) Patent Application Publication
(10) Pub. No.: US 2007/0040296 A1
(43) Pub. Date: Feb. 22, 2007

(54) Soap saver

(76) Inventor: Singleton C. Moore, Jackson, MS (US)

Correspondence Address: JAMES RAY & ASSOCIATES, 2640 PITCAIRN ROAD, MONROEVILLE, PA, 15146, US

(21) Appl. No.: 11/502,136

(22) Filed: Aug. 10, 2006

Related U.S. Application Data
(60) Provisional application No. 60/708,502, filed on Aug. 16, 2005.

(51) Int. Cl. B29C 47/00; G01F 11/00

(52) U.S. Cl. 264/211.11; 222/321.7

(57) ABSTRACT

An apparatus for using small leftover pieces of bar soap. The apparatus comprises a container member having a first predetermined shape and formed of a first predetermined material for holding such small leftover pieces of bar soap and mixing such small leftover pieces of bar soap with a predetermined fluid. There is a frame for retaining such container in an upright position. The frame having a second predetermined shape and formed of a second predetermined material. The invention includes pump mechanism for dispensing the liquid soap formed in the container member from such small pieces of bar soap and such predetermined fluid.

### CROSS REFERENCE TO RELATED APPLICATIONS

This application is closely related to and claims benefit from U.S. Provisional Application Ser. No. 60/708,502 filed Aug. 16, 2005.

### FIELD OF THE INVENTION

The present invention relates, in general, to a soap saver, and, more particularly, the present invention relates to an apparatus for reclaiming leftover soap pieces and converting them to liquid soap.

### BACKGROUND OF THE INVENTION

Bar soap is the most commonly used product for use in the bathroom, powder room or with any sink for washing ones hands. Or in taking a bath or shower. However, bar soap often ends up in small pieces that through use become too small to comfortably fit into a person's hands. In the bath tub these small pieces are normally to small to bathe with and frequently end up on the shower floor, bathtub or simply get tossed into waste basket.

Some people try to combine several small pieces together by squeezing them together while they are wet to form a larger piece and possibly reuse them in that manner. However, this is time consuming and many times the pieces do not stay together well. Saving these small pieces for reuse would not only be beneficial but would also be cost effective.

Thus, it would be advantageous if were possible to save these small pieces and recycle these pieces and reuse them in a simple and convenient manner.

### SUMMARY OF THE INVENTION

In a first aspect the present invention provides an apparatus for using small leftover pieces of bar soap. The apparatus comprises a container member having a first predetermined shape and formed of a first predetermined material for holding such small leftover pieces of bar soap and mixing such small leftover pieces of bar soap with a predetermined fluid. There is a frame for retaining such container in an upright position. The frame having a second predetermined shape and formed of a second predetermined material. The invention includes a means for dispensing a liquid soap formed in the container member from such small pieces of bar soap and such predetermined fluid.

In a second aspect the present invention provides a process for converting small pieces of leftover bar soap into a liquid soap. The process comprises the steps of selecting such small pieces of leftover bar soap and a step of placing such pieces of bar soap selected in the previous step into a preselected container member retained in a preselected frame for holding such container member in an upright position. There is a step of mixing the pieces of bar soap placed in the preselected container in a previous step with a preselected fluid and a step of squeezing the container containing the mixture of such preselected fluid and such pieces of bar soap to form a liquid soap. A step of providing the apparatus with a pump mechanism is next and a step of dispensing such liquid soap formed in the previous step through the pump mechanism provided previously as needed.

### OBJECTS OF THE INVENTION

It is, therefore, one of the primary objects of the present invention to provide an apparatus for reusing small pieces of leftover bar soap.

Another object of the present invention is to provide an apparatus for reusing small pieces of leftover bar soap by converting them into liquid soap.

Still another object of the present invention is to provide an apparatus for reusing small pieces of leftover bar soap that uses a liquid soap dispenser.

Yet another object of the present invention is to provide an apparatus for reusing small pieces of leftover bar soap that is simple to use.

It is yet another object of the present invention to provide a process for converting such small pieces of bar soap into liquid soap.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the complete apparatus according to an embodiment of the invention.

FIG. 2 is a perspective view of the container and frame with the rim for use with snap on type soap pump.

FIG. 3 is a perspective view of the container and frame with the rim for use with screw on type soap pump.

FIG. 4 is an enlarged perspective view of the soap pump for use with the apparatus.

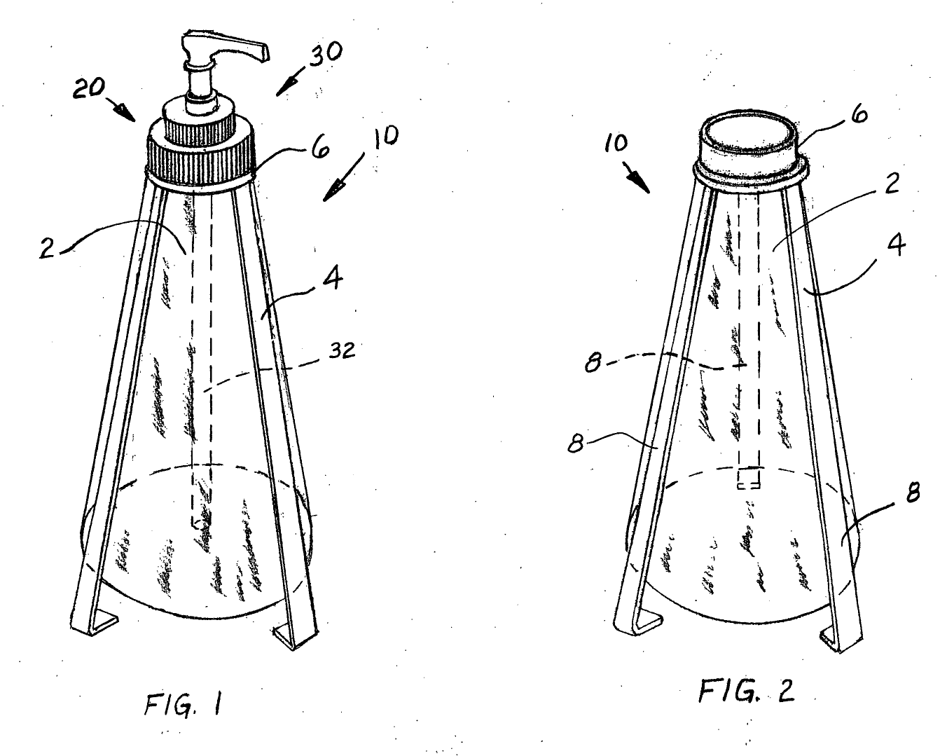

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for utilizing small pieces of leftover bar soap that is too small to use as bar soap. Such apparatus 10 comprises a container member 2 having a first predetermined shape and formed of a first predetermined material for holding such small pieces of leftover soap and mixing such leftover pieces of soap with a predetermined fluid. The apparatus 10 has a frame member 4 for securing such container member 2 in an upright position. Such frame 4 has a second predetermined shape and is made of a second predetermined material. There is, further, a means, generally designated 20, engageable with said frame 4 and said container 2 for dispensing the liquid soap formed in the container member 2 from such pieces of bar soap and such predetermined fluid.

It is presently preferred that such predetermined fluid is water. However, it is within the scope of the invention that predetermined fluid could also include a fragrance or an additive such as aloe or other additives presently found in many commercial liquid soaps.

The frame 4 of the apparatus 10 further includes a rim member 6 formed at the top of the frame 4. Such container member 2 can be removably secured to such rim member 6 or it could be molded to the rim member 6 formed on the top of the frame 4. It is presently preferred that such contained member be molded or permanently attached to such rim member 6.

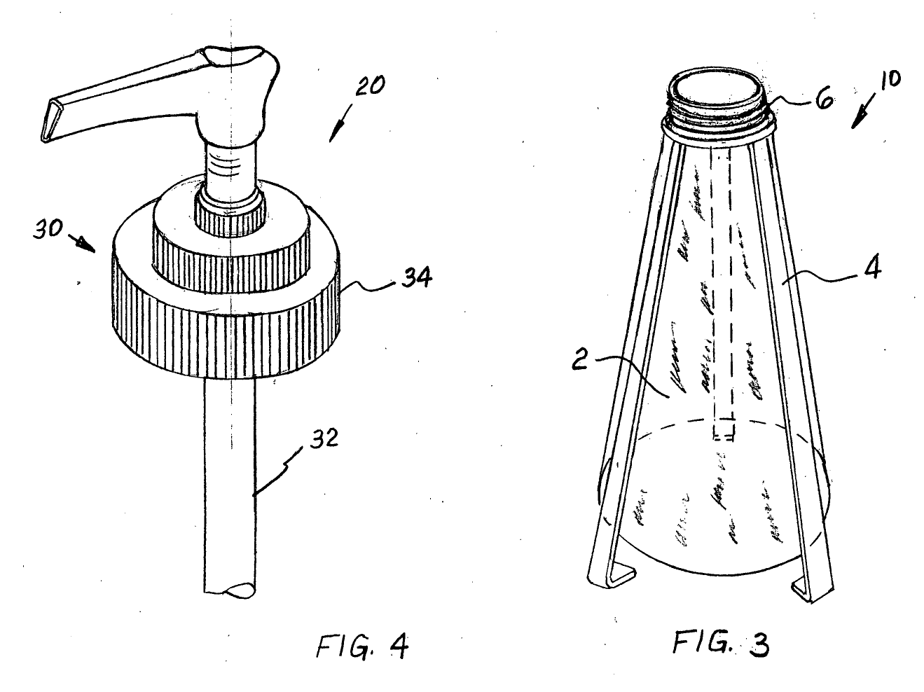

The means 20 for dispensing such liquid soap that was formed in the container is a liquid soap pump, generally designated 30. Such liquid soap pump 30 includes a tube member 32 which extends to a bottom portion of the container member 2. The liquid soap pump 30 is engageable with the rim member 6 of the frame 4 by means of one of a screw on cap 34 and a snap on cap. Where a screw on cap 34 is used the rim member 6 has threads disposed on the exterior surface of the rim member 6 as seen in FIG. 3, whereas if the cap is a snap on cap such rim member has a smooth finish, as seen in FIG. 2, wherein the cap merely snaps onto the rim member 6.

Such container member 2 is flexible so that when such pieces of leftover bar soap are mixed with water the container member can be squeezed to speed up the process of converting the bar soap to liquid soap. Thus, it is preferred that such container member be made of a plastic material. Such plastic is selected from a group including polyethylene, polyvinyl chloride and polypropylene. It is presently preferred that such plastic is polyethylene.

The first predetermined shape of such container member is substantially conical as is seen in the Drawing Figures. Further, such second predetermined shape of the frame 4 is substantially a tripod having legs 8. Although it referred to as a tripod it is within the scope of the invention that such legs could be four instead of the normal; three for a tripod.

Such second predetermined material for the frame 4 is selected from one of plastic and metal and it is presently preferred that such material be plastic.

In a second aspect the present invention provides a process for converting small pieces of leftover bar soap into a liquid soap. The process comprises the steps of selecting such small pieces of leftover bar soap and a step of placing such pieces of bar soap selected in the previous step into a preselected container member 2 retained in a preselected frame 4 for holding such container member 2 in an upright position. There is a step of mixing the pieces of bar soap placed in the preselected container in a previous step with a preselected fluid and a step of squeezing the container member 2 containing the mixture of such preselected s fluid and such pieces of bar soap to form a liquid soap. A step of providing the apparatus 10 with a pump mechanism 30 is next and a step of dispensing such liquid soap formed in the previous step through the pump mechanism 30 provided previously as needed.

As stated previously such pump mechanism 30 includes a tube member 32 which extends to a bottom portion of the container member 4. Also, as stated previously it is preferred that such predetermined fluid be water.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for using small leftover pieces of bar soap, said apparatus comprising:
(a) a container member having a first predetermined shape and formed of a first predetermined material for holding such small leftover pieces of bar soap and mixing such small leftover pieces of bar soap with a predetermined fluid;
(b) a frame for retaining said container in an upright position, said frame having a second predetermined shape and formed of a second predetermined material; and
(c) a means for dispensing a liquid soap formed in said container from such small pieces of bar soap and said predetermined fluid.

2. The apparatus, according to claim 1, wherein said predetermined fluid is water.

3. The apparatus, according to claim 1, wherein said frame has further includes a rim member formed at the top of said frame.

4. The apparatus, according to claim 2, wherein said container member is one of removably secured and molded to said rim member formed on said top of said frame.

5. The apparatus, according to claim 4, wherein said container ember is molded to said rim member formed on said top of said frame.

6. The apparatus, according to claim 3, wherein said means for dispensing said liquid soap formed in said container is a liquid soap pump.

7. The apparatus, according to claim 6, wherein said liquid soap pump includes a tube member which extends to a bottom portion of said container member.

8. The apparatus, according to claim 6, wherein said liquid soap pump is engageable with said rim member of said frame by means of one of a screw on cap and a snap on cap.

9. The apparatus, according to claim 8, wherein said liquid soap pump is engageable with said rim member by means of a screw on cap.

10. The apparatus, according to claim 1, wherein said container member is flexible.

11. The apparatus, according to claim 10, wherein said container member is made of plastic.

12. The apparatus, according to claim 11, wherein said plastic is selected from one of polyethylene, polyvinyl chloride and polypropylene.

13. The apparatus, according to claim 12, wherein said plastic is polyethylene.

14. The apparatus, according to claim 1, wherein said first predetermined shape is substantially conical.

15. The apparatus, according to claim 1, wherein said second predetermined shape is substantially a tripod.

16. The apparatus, according to claim 1, wherein said second predetermined material is selected from one of plastic and metal.

17. The apparatus, according to claim 16, wherein said second predetermined material is plastic.

18. A process for converting small pieces of leftover bar soap into a liquid soap, said process comprising the steps of:
(a) selecting such small pieces of leftover bar soap;
(b) placing such pieces of bar soap selected in step (a) into a preselected container member retained in a preselected frame for holding said container member in an upright position;
(c) mixing said pieces of bar soap placed in said preselected container in step (b) with a preselected fluid;
(d) squeezing said container containing said mixture of said preselected fluid and said pieces of bar soap to form a liquid soap;
(e) providing said apparatus with a pump mechanism; and
(f) dispensing said liquid soap formed in step (e) through said pump mechanism provided in step (f) as needed.

19. The process, according to claim 18, wherein said pump mechanism provided in step (e) includes a tube member which extends to a bottom portion of said container member.

20. The process, according to claim 18, wherein said preselected fluid used to mix with said pieces of bar soap in step (c) is water.
